(19) United States
(12) Patent Application Publication
(10) Pub. No.: US 2014/0297400 A1
(43) Pub. Date: Oct. 2, 2014

(54) METHOD AND SYSTEM FOR MEDIA ADVERTISING CAMPAIGN SALES AND ALLOCATION

(71) Applicant: Tuomas W. Sandholm, Pittsburgh, PA (US)

(72) Inventor: Tuomas W. Sandholm, Pittsburgh, PA (US)

(21) Appl. No.: 14/227,413

(22) Filed: Mar. 27, 2014

Related U.S. Application Data
(60) Provisional application No. 61/805,711, filed on Mar. 27, 2013.

(51) Int. Cl. G06Q 30/02

(52) U.S. Cl. CPC G06Q 30/0243; G06Q 30/0249; G06Q 30/0273
USPC 705/14.42; 705/14.48; 705/14.69

(57) ABSTRACT

A method and system for managing media advertising campaigns accesses a set of programming data that contains various attributes of media assets that a media service provider will present to consumers. A media advertising campaign manager receives various buyer criteria for the inclusion of advertisements in a buyer's advertising campaign. The system uses the attributes in the data set to develop an advertising campaign that satisfies the buyer's criteria. In various embodiments, the method system may consider buyer preferences, seller criteria, and campaign requests for other buyer's so that the advertising campaign is developed in a manner that maximizes a revenue opportunity for the media service provider.

### RELATED APPLICATIONS AND CLAIM OF PRIORITY

This patent document claims priority to U.S. provisional patent application No. 61/805,711, filed Mar. 27, 2013. The disclosure of the provisional patent application is incorporated herein by reference in its entirety.

### BACKGROUND

Current methods of selling advertisements on television, radio and other media outlets are very inefficient. For example, television ad sales often involve manual negotiation. However, sales representatives typically do not have access to scheduling information. Often, a sale is completed, but the sales representative later finds that the buyer's campaign cannot be scheduled, either due to broadcast schedule changes or because other sales representatives have sold advertising campaigns that cannot be mapped onto the inventory together with the campaign in question. In cases such as this, the sales representative must provide the buyer with makegoods (e.g., free advertising inventory from the future), resulting wasted work time and effort for the sales representative and lost revenue opportunities for the media outlet.

In addition, current methods of selling media advertising often involve purchase prices that are set by the seller. They do not adequately account for what programs, times, or other parameters may be of most value to each individual buyer. In cases such as this, the seller may be losing opportunities for additional revenues from a buyer.

Further, current media sales methods lack efficient mechanisms to manage cross-media advertising campaigns. Sales of scheduled advertisements across broadcast television, cable television, radio and streaming media outlets can involve very different data sets, parameters and values. Sales representatives must manually gather and monitor data from multiple systems to determine what packages to offer to a potential buyer. Buyers face exposure problems in crafting together cross-media campaigns from multiple sources because they have to commit at some sources before knowing whether they will get what they want from the other sources.

This document describes methods and systems to address some or all of the issues described above, as well as other shortcomings in current advertising sales and scheduling.

### SUMMARY

In an embodiment, a system for managing media advertising campaigns includes or accesses a set of programming data comprising temporal attributes and non-temporal attributes for a plurality of media assets that a media service provider will present to consumers. The system also includes a processor and a computer-readable medium containing programming instructions that, when executed, cause the processor to implement a media advertising campaign manager.

In one embodiment, when implementing the media advertising campaign manager the system causes an electronic device to implement a user interface that displays user-selectable purchasing criteria for advertisements to be placed in one or more of the media assets. The system receives, via the user interface, a selection of one or more of the purchasing criteria for a purchase of advertisements by a first buyer; uses the temporal attributes and non-temporal attributes in the data set to automatically develop an advertising campaign for the first buyer that satisfies the selected purchasing criteria, and presents indicia of the advertising campaign to a user to review.

In another embodiment, when implementing an advertising campaign manager, the system may receive one or more placement criteria for placement of advertisements in an advertising campaign, use the temporal attributes and non-temporal attributes in the data set to automatically develop the advertising campaign so that it satisfies the placement criteria, and generate one or more data files that contain parameters for the advertising campaign, including an association of at least one advertisement with at least one of the media assets.

In another embodiment, a method of managing a media advertising campaign includes receiving, via user interface and/or other input mechanism, one or more user-selected purchasing criteria for a purchase of advertisements by a first buyer. The method includes accessing a set of programming data comprising temporal attributes and non-temporal attributes for a plurality of media assets that a media service provider will present to consumers; using the temporal attributes and non-temporal attributes in the data set to automatically develop an advertising campaign for the first buyer so that the advertising campaign associates the advertisements with various media assets in the database and satisfies the user-selected purchasing criteria; and presenting indicia of the advertising campaign to a user to review.

In various embodiments, the system may receive and/or enable the user to identify a start time, end time or duration for the advertising campaign. It may also receive and/or enable the user to identify a budget constraint for the advertising campaign. If so, then the media advertising campaign manager may develop the advertising campaign so that it satisfies the budget constraint and the identified start time, end time or duration.

Optionally, the system may enable the user to identify, or it may otherwise receive, one or more alternative criteria for the campaign, along with identify one or more different monetary values that the buyer will pay if any of the alternative criteria are met. For example, an alternative criterion may include an exclusivity preference that comprises an exclusive time period and a competitive restriction for the placement of advertisements by a second buyer in one or more of the media assets during the exclusive time period. If so, then when developing the advertising campaign the system may use the different monetary value for the exclusivity preference to determine whether satisfying the exclusivity preference will maximize a revenue opportunity for the media service provider. If satisfying the exclusivity preference will maximize a revenue opportunity for media service provider, then the system may also develop an advertising campaign for the second buyer so that media assets of the second buyer are positioned in a manner that does not violate the exclusivity preference of the first buyer. The user may specify the different monetary values by expressing preferences over targeting, campaign control features or both.

Optionally, one or more of the purchasing criteria may include a target audience criterion such as: a requirement that a viewer have purchased a specified good or service within a time period; a requirement that a viewer have exhibited a viewing pattern over a time period; a requirement that a viewer has publicly expressed positive feedback on a social network for a media asset in the advertising campaign; or a requirement that a viewer has not publicly expressed negative feedback on a social network for a media asset in the advertising campaign.

Optionally, the system may enable the user to identify, or it may otherwise receive, an overall time period for the advertising campaign, define a time unit that is a subunit of the overall time period, and identify a smoothness criterion. The smoothness criterion would represent a measurement of a maximum amount of change in a volume of advertisements allocated to each of the time units for the advertising campaign. If so, then the system may develop the campaign so that the advertisements for media assets that are scheduled television programs are allocated to the time units in a manner that does not violate the smoothness criterion.

Optionally, the system may enable the user to identify, or it may otherwise receive, a separation criterion that includes a user-specified type of advertisement and a minimum distance that the advertising campaign should maintain between placement of the first buyer's advertisements and placement of advertisements of the user-specified type. If so, then when developing the advertising campaign the system may do so such that the first buyer's advertisements and placement of advertisements of the user-specified type are positioned in a manner that does not violate the separation criterion.

Optionally, the user interface may include an input by which the interface may receive from a user, or the system may otherwise receive, a categorization of at least one of the purchasing criteria as a preference. For at least one of the criteria that is categorized as a preference, the system may receive various levels for the preference criterion and, for each level, a level-specific bonus amount that the first buyer will pay if the preference is satisfied in the advertising campaign.

Optionally, the user interface may include an input by which the interface may receive from a user, or the system may otherwise receive, a categorization of two or more of the purchasing criteria as preferences. For each of the criteria that are categorized as a preference, the system may receive a bonus amount that the first buyer will pay if the preference is satisfied in the advertising campaign, and at least one constraint on how the bonus amounts may be aggregated. If so, then when developing the advertising campaign the system may do so in a way that will satisfy at least one of the preferences that maximize a revenue opportunity for the media services provider. The system also may determine a cost for the campaign that includes the bonus amounts as limited by the constraint.

Optionally, the system may enable the user to identify, or it may otherwise receive, a zone or an interconnect for at least a portion of the campaign. If so, then when developing the advertising campaign the system may develop the portion of the campaign so that whenever a slot is allocated to an interconnect campaign, then an ad running in that slot is presented in all zones that constitute the interconnect.

Optionally, the system may access a set of profile data for the first buyer and use the profile data to determine a recommended value for the purchasing criterion for the first buyer. The system may include the recommended value in the campaign as a default value. The system may also present the recommended value to the user as a default value via the user interface. The user interface may provide a user-selectable input wherein the system may receive an acceptance of the default value or a replacement of the default value with a user-selected value.

Optionally, when developing the advertising campaign, the system may identify a plurality of advertisements to include in the advertising campaign. For each of the video advertisements, the system may preliminarily assign the advertisement to a position in the campaign that comprises a media asset or a temporal position. The system may then present the campaign to the first buyer with at least one advertising assignment presented as an unscheduled commitment for which the position will be assigned or confirmed after the first buyer accepts the advertising campaign. When assigning each advertisement to a position, the system may determine that multiple candidate positions have attributes that meet each constraint in the first buyer's purchasing criteria. If so, then the system may select, from the candidate media assets, a group of media assets and position assignments that maximize a revenue opportunity for the media service provider while remaining within the budget criteria. The system may then include the group of media assets and position assignments in the advertising campaign.

Optionally, the system may provide an input by which the interface may receive from a user a selection of at least one preferred slot within a pod of programming, along with a monetary value that the first buyer will pay if the campaign includes an advertisement in the preferred slot. If so, then when implementing the advertising campaign the system may identify a set of advertisements to include in the advertising campaign, and it may determine whether assigning an advertisement to the preferred slot will maximize a revenue opportunity for the media service provider. If assigning an advertisement to the preferred slot will maximize a revenue opportunity for the media service provider, then the system may assign an advertisement to a position that corresponds to the preferred slot.

Optionally, the instructions to develop the advertising campaign further comprise additional instructions to: receive a second set of purchasing criteria for a purchase of advertisements by a second buyer; use the second set of purchasing criteria and at least some of the attributes in the set of programming data to develop a second advertising campaign for the second buyer; determine that the first advertising campaign and the second advertising campaign would, if implemented, each place an advertisement in a common position; determine whether placing the advertisement from the first advertising campaign in the common position or placing the advertisement from the second advertising campaign in the common position will maximize a revenue opportunity for the media service provider; and place the advertisement from the advertising campaign that will maximize the revenue opportunity in the common position, and modify the other advertising campaign to identify a new position for the other advertising campaign's advertisement such that the new position will satisfy the purchasing criteria for the buyer of the other advertising campaign. The system may also reoptimize an allocation of inventory to each campaigns in light of a new campaign request, a change in supply of inventory, or a change in demand projections.

Optionally, after the advertisement campaign has begun the system may determine that the media service provider was, or likely will be, unable to satisfy a purchasing criterion that was classified as a constraint. If so, then it may identify a make-good action that has a value that is appropriate to compensate the first buyer for the media service provider's inability to satisfy the purchasing criterion that was classified as a constraint, and it may automatically cause the make-good action to be offered or given to the first buyer or to a representative of the media service provider.

Optionally, when developing the advertising campaign the system may identify advertisements to include in the advertising campaign; and it may assign the advertisement to positions in a media assets in multiple media, such as at least two of the following: a television program; an on-demand program that is distributed via an online audio/video distribution service; an electronic game; an electronic publication; or a web page.

In some embodiments, after the system presents indicia of the advertising campaign to the user they system receive a response comprising an acceptance of a first portion of the advertising campaign and a rejection of a second portion of the advertising campaign. If so, it may determine an updated price for the first portion of the advertising campaign, modify the advertising campaign to exclude the second portion of the advertising campaign, and present the modified advertising campaign and the updated price to the user for review.

Optionally, when developing the advertising campaign the system may automatically identify an alternate criterion that is an alternative or supplement to at least one of the purchasing criteria. If so, then the system may use the temporal attributes and the non-temporal attributes in the data set to automatically develop an alternative advertising campaign for the first buyer that satisfies the purchasing criteria as modified by the alternate criterion, present information relating to the alternative advertising campaign to the user. The system may also receive a user selection of one of the presented advertising campaigns.

Optionally, the system may identify an undersell constraint that comprises a restriction on sale of advertisements for a particular media asset or other unit of inventory. If so, then when developing the advertising campaign the system may doing so such that the advertising campaign satisfies the undersell constraint. Alternatively, the system may relax a supply constraint throughout a campaign on a per-inventory-segment basis, and it may reoptimize one or more campaigns based on the relaxing. For example, the system may identify an oversell constraint that comprises a permission to make conflicting advertising commitments for a particular media asset or other unit of inventory. If so, then after developing the advertising campaign the system may automatically generate a report to the media service provider identifying any conflicting advertisement commitments.

Optionally, the system also may provide a property manager configured to receive temporal attributes, non-temporal attributes or both for a new media asset. The property manager may add the received attributes for the new media asset to the set of programming data for use in future advertising campaigns.

Optionally, the media advertising campaign manager further comprise instructions that, when executed, cause a display device to present a seller-side user interface by which a seller may enter a plurality of seller-side criteria for the placement of advertisements in the advertising campaign. The seller-side criteria may include criteria such as: a premium value to be added to a bid or budget received from the first buyer; a requirement to provide the first buyer with an audience having one or more specified attributes; or a rule to factor a make-good cost in a revenue analysis when developing the advertising campaign. the media advertising campaign manager may develop the advertising campaign so that it also satisfies each of the seller-side criteria.

Optionally, the system also may cause an electronic device to present a seller-side user interface via which the advertising campaign is presented. When it receives a request to modify the presented advertising campaign, it may cause a processor to modify the advertising campaign to implement the received modification request.

In some embodiments, the system may include a set of additional programming data comprising temporal attributes and non-temporal attributes for a plurality of media assets that a second media service provider will present to consumers. If so, then the advertising campaign further also may use the parameters in the data set for the second media service provider so that the advertising campaign places advertisements in media assets for each of the media service providers.

In some embodiments, the system may cause an electronic device to output a scheduling interface that displays a report of the campaign including the association of at least one advertisement with the at least one of the media assets. The scheduling interface may permit a user to modify a distribution of at least one of the advertisements to a different position in the campaign.

### BRIEF DESCRIPTION OF THE DRAWINGS

FIG. 1 is a block diagram of certain elements of a system that may be used to manage sales of advertisements to be placed in a media service.

FIGS. 2-4 illustrate examples of various sections of an embodiment of a media service advertising campaign manager user interface.

FIGS. 5-6 illustrate examples of various sections of an embodiment of a media asset property manager user interface.

FIG. 7 illustrates an example of a section of a scheduling user interface.

FIG. 8 is a flowchart illustrating an example process of building advertising campaigns.

FIG. 9 is a block diagram representing internal hardware that may be used to contain or implement the various computer processes and systems discussed in this document.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

As used in this document, the term “media service” refers to any service that presents video or audio programming in live or pre-recorded format. Examples include over-the-air broadcast television, cable television, radio, webcasting, datacasting, Internet video streaming, Internet radio, podcasting and other analog or digital media outlets containing programming in which advertisements may be inserted at particular scheduled times. The scheduled times can be an actual clock time (as in the case of a television or radio program), or a time with respect to a reference time (such as number of minutes and/or seconds after the start time of a streaming program). In some embodiments, a media service also may include a service that presents video and/or other visual media assets on an on-demand basis for display on an electronic device. Examples include Internet advertising on web pages or electronic publications such as electronically delivered books, magazines or newspapers, mobile electronic device advertising and electronic game in-game advertising. In such embodiments, advertisements may be allocated to each impression of a particular media asset, on a temporal basis such as one based on a time when a viewer views the asset, or on a content basis such as whenever certain content is presented to a view on a screen of the viewer's electronic device.

As used in this document, a “media asset” is a unit of media that will be presented to consumers of a media service (i.e., viewers and/or listeners). In the context of video or audio programming, a media asset may be a program, a group of programs, or a unit of time in which programs will be presented such as a slot or pod or impression. Such media assets may be of a fixed length of time (such as a television program) or designated to be dynamic such that the spot length was changed, or was unknown at least at the time when it was first sold (such as dynamic pods that are adjusted as a live program is presented, as may be the case in a sporting or other live event). In the context of non-video visual media, a media asset may be a particular page or part of a page of a website or other digital media asset, and in some embodiments may be allocated to advertisements as an impression (e.g., an instance when a viewer navigates to a particular news page on the web), with or without a temporal condition.

As used in this document, a “temporal parameter” refers to a measurement or value of a time associated with a media asset distributed by a media service. Examples of temporal parameters include a scheduled start time, a scheduled end time, a day part, a program run time, a time within a program or advertising pod, such as a scheduled commercial break time, a position within a commercial break time, a frame count within a program, a position before or after an event in a program, and the like.

As used in this document, an “advertising campaign” may be a set of units of inventory of a media service for which the media service will include advertisement messages that share a common idea or theme, or which come from a common buyer. A campaign can be as specific as a collection of specific units, or it can be a collection of criteria for the association of advertisements with units. The campaign could then be fulfilled with any one of many possible sets of inventory units. The media service will present the ads to consumers of various media assets. An advertising campaign may be prepared and presented to include a single media service (such as a television network) or multiple media services (such as television, cable, streaming media, and/or web pages).

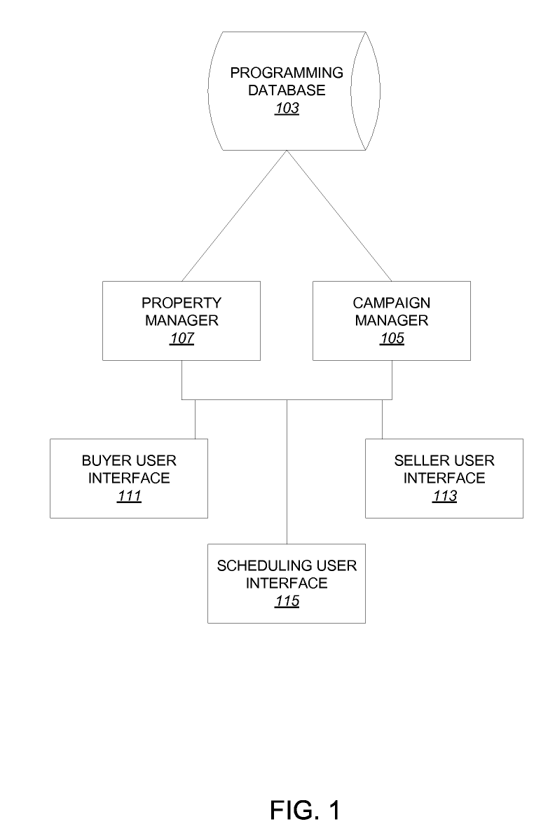

FIG. 1 illustrates a system that may be used to manage sales of advertisements in a media service. The system may include a set of programming data 103, which can be one or more databases or other data storage structures containing temporal attributes and other attributes for various media assets that are scheduled to broadcast, stream or otherwise be presented. In addition to temporal attributes, attributes that are stored for one or more of the media assets may include non-temporal attributes such as program attributes (such as title, genre, various ratings, parental guidelines, meta-tags), media type (e.g., broadcast television, cable television, cable, webcast, etc.), network attributes (e.g., network name, typical programming genre or other type, size, or quality), or viewer (or target viewer) demographic (e.g., male or female, age range), audience characteristics (such as income level, hobbies, education level, education area, profession, personality type, body type), consumer behavioral attributes on the media (such as clicking behavior attributes, clickstream, behavior on the TV remote, purchasing attributes on that media, eye-tracking attributes, viewing habits), behavioral attributes outside the presented media (e.g., the above-mentioned attributes from other media or other sources, purchasing habits, detailed purchasing history), geographical attributes (of the consumer in general, of the consumer at the moment, of the consumer's residence(s), of the consumer's movements, of the viewer's proximity to points of interest, etc.), attributes of the device(s) that the user is using (and how) currently or typically, social attributes (such as which TV shows the person has liked or disliked or commented on positively or commented on negatively on a social network such as Facebook or Twitter), or other measurements of viewership and the like.

In some embodiments, attributes for media assets may include content-based attributes that describe or reflect the content of the media asset. Examples include show title, genre, actors/actresses who appear in the asset, language spoken, or even particular actions that appear in the asset (such as an actor drinking a beverage or driving a car).

Thus, the system may permit targeting based on a combination of any number of attributes, for example, combining show, demographic, and even behavioral attributes. These attributes can be at any level of aggregation ranging from individuals to broad collections of viewers, depending on how fine an audience segmentation the targeting technology and data sources support.

In various embodiments, some of the attributes can be measured. Others may be only statistically measured (e.g., 17% of the viewers of this show are males that earn more than $100,000). Other attributes can be inferred. Yet other attributes can be self-declared via subscriptions, questionnaires, and the like. The programming data may relate to a single media service provider or multiple service providers, each of which are presenting media assets in which ads may be purchased.

The system may include an advertising campaign manager 105 which is a set of one or more software modules configured to receive ad buyer purchasing criteria for the purchase of advertisements. The advertising campaign manager 105 may use the purchasing criteria to help the buyer or a sales representative create an ad campaign based on those criteria and available advertising inventory. The advertising campaign manager 105 also may be used to schedule advertisements for an advertising campaign during or after the sale. The advertising campaign manager 105 also may be used to adjust the scheduling of advertisements for an advertising campaign after the advertising campaign has been sold to a buyer.

The system also may include a media asset property manager 107 which is a set of one or more software modules configured to allow a media service provider or sales representative to add temporal and non-temporal attributes for new media assets (i.e., programs) to the set of programming data, and optionally to update the attributes associated with existing programs and/or the values of those attributes and/or the probability distribution over values or combinations of values of those attributes. The media asset property manager may include a user interface with menus, fields and other tools that enable a media service provider, its sellers or an authorized representative to enter such data.

Ad buyers and media service providers/sellers may interface with the advertising campaign manager by one or more user interfaces. A buyer user interface may 111 may include input fields, user-selectable menus or other devices by which a buyer, a buyer's representative, or a sales representative who has access to a buyer's purchasing criteria may enter or select various purchasing criteria for the buyer. A seller user interface 113 may include input fields, user-selectable menus, or other devices by which a media service provider or its representative may add or modify temporal or non-temporal attributes (and their values and probability distributions over values or combinations of values) for new and/or existing media assets. The system also may include a scheduling user interface 115 having input fields, user-selectable menus, or other devices by which a media service provider or its representative may add or modify temporal or non-temporal attributes (and their values and probability distributions over values or combinations of values) for new and/or existing media assets, as well as enter information that will cause the system to assign or adjust the positioning of advertisements to particular positions within programs, pods, or other temporal units associated with media assets. The seller user interface 113 and the scheduling user interface 115 may be the same item, parts of the same item (such as different screens or pages of an interface), or separate items.

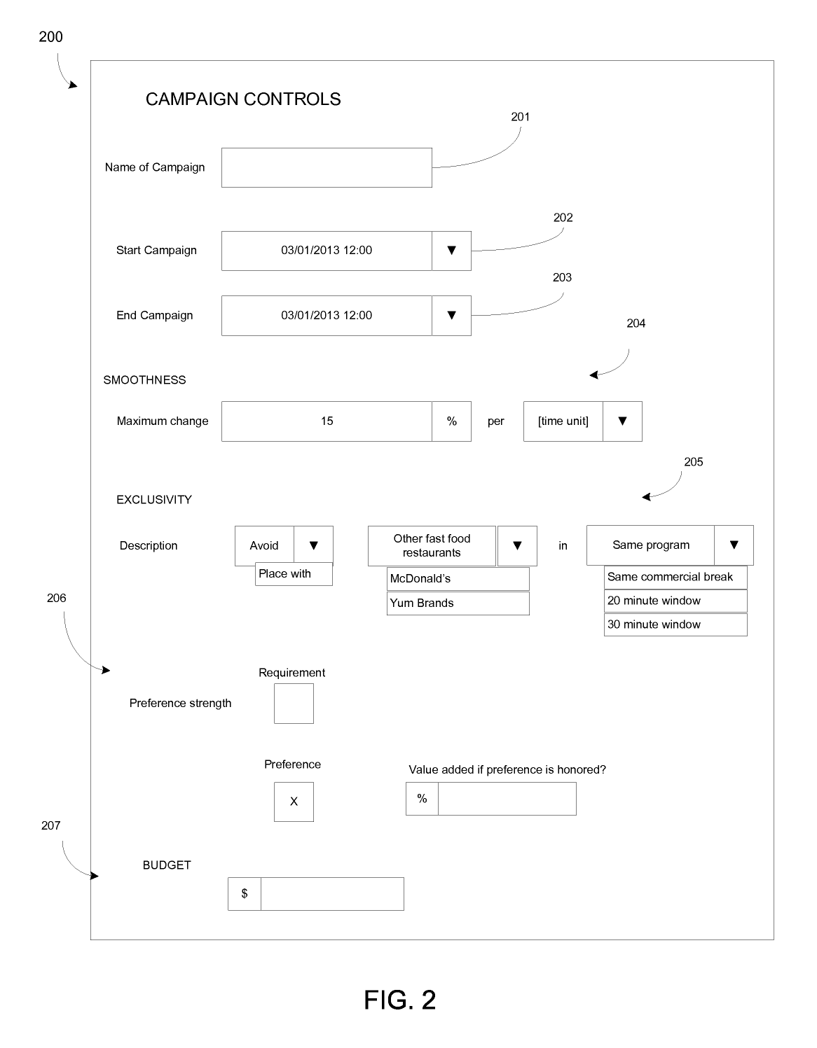

FIG. 2 illustrates an example of a section of a media advertising campaign manager buyer user interface 200 by which a user may enter various buyer purchasing criteria. Purchasing criteria that relate to scheduling of or target audience delivery for an advertisement or group of advertisements also may be considered to be scheduling criteria, and this document will use the terms “purchasing criteria” and “scheduling criteria” interchangeably except where the context dictates that a criterion relates to only purchasing or only scheduling. Where referring particularly to scheduling or allocation of inventory to a campaign, this document may use the term “placement criteria.” The seller may use this interface 200 to specify desired or required temporal parameters, attributes, or placement requirements or restrictions for advertisements that will be included in an advertising campaign. Optionally, the interface may permit a user to define each constraint and each preference at a variety of levels of scope, such as by pod, show, entire semester of a show, entire semester, by a temporal range (e.g., between a particular start time and end time, or by a unit of time on a calendar such as a week or month).

Input fields for temporal parameters may include those such as a campaign start time field 202, an end time field 203 (each of which may be expressed in terms of clock time such as hour and minute, by date, by both clock time and date, or by some other unit of time measure), smoothness criteria 204 and other scheduling requirements or other indicators of time. Other input fields and temporal criteria received may include those such as frequency constraints, in which the user specifies an upper limit, lower limit or range of frequency that an advertisement or group of advertisements may appear within a particular media asset, group of media assets, particular demographic, or the overall campaign.

A frequency constraint can also be at a finer level if the particular measurement technology used supports that. For example, a constraint may state that the campaign has to reach a particular individual (or a set of individuals in aggregate) at least k times but no more than k′ times. This may even be measured across multiple shows or other media assets.

Input fields and temporal criteria received may include separation constraints, in which the user specifies a minimum or maximum temporal distance that the media service provider must maintain between appearances of ads within a sequential block of one or more media assets. Such a distance could be as small as a unit of one (meaning that, in the case of a minimum distance that two ads may not air-back-to-back) up to any distance amount. The separation constraints can be used to specify separation between the buyer's own advertisements and/or separation between the buyer's advertisements from competitors' advertisements.

Temporal criteria could also be specified to vary throughout a campaign, such as a requirement to place more ads early in a campaign than later in the campaign or vice versa. Another example is ramping the flow of advertising units within a campaign up as the advertised item's product launch is approaching. Any constraints on the profile of flow of advertisement units over time within the campaign can be used here.

Smoothness criterion input fields 204 may include fields that receive criteria for time units and a maximum amount of change in the distributions of advertisements for the campaign over all time units within the time period. For example, a week-long campaign that includes a smoothness criterion of 10% per day will ensure that ads for the buyer are smoothly distributed over the week and not bundled into any particular day so that no day contains more than 10% more ads than any other day. As another example, a campaign for a 13-week season of a television program that includes a smoothness criterion of 15% per episode are smoothly distributed over the entire season and not bundled into any particular episode. Optionally, the interface may permit the user to specify a media asset type (e.g., scheduled television, on-demand television, or Internet streaming) to which the smoothness criterion will apply.

Input fields for non-temporal parameters may include those such as exclusivity criteria 205, a budget 207, and others. Exclusivity criteria input fields 205 may solicit entries such as those that include a competitive restriction for the placement of advertisements by at least one other buyer in one or more of the media assets that will contain the buyer's advertisement, along with a scope for the exclusivity. The scope can be, for example, a show or a set of shows, or a specific time window, or a combination of the two. The scope can also be a pod, set of pods, or part of a pod. For example, a competitive restriction may include a criterion to avoid placing an advertisement for a first buyer in any program or specified time block that also contains ads for other buyers who are specifically identified, or who are in a particular product category. This system's detailed approach to slot scheduling within each pod also may enable richer pod-level preferences and constraints related to competition, such as, “I am willing to be in the same pod with my competitor, but not back to back with the competitor.” A competitive restriction may also include a requirement, such as a requirement that two specific ads or ads for two buyers be placed within the same program or within a particular time period from each other. Competitive constraints and preferences also may include requirements to refrain from placing competitive advertisements within specific media assets regardless of whether the buyer also has an ad placed within that media asset.

Budget constraints 207 may be established at varying levels of granularity. For example, the system may be configured to receive an overall maximum budget for the campaign, an overall minimum budget for the campaign, a budget for a specified portion of the campaign, a bonus amount that the buyer is willing to pay if the campaign satisfies certain criteria, a varying budget with rules indicating how the budget will increase (linearly, piecewise linearly, or nonlinearly) as the audience delivered in the campaign increases, a budget restriction (such as an indication of an amount that the buyer will pay only if a certain audience demographic is delivered in a portion of the campaign), or budgets that are conditioned on certain temporal ad placement criteria being satisfied (such as an ad being placed in a particular program on a particular date). Optionally, the system may even give the user an ability to impose a counting constraint in which the user specifies a first number of media assets or temporal positions that are of interest, but a limitation that the user will only pay for a second (and smaller) number of ad placements. This effectively leaves it to the media service provider and/or the system to place the second number of ads within any of the first number of media assets.

Additional constraints (which can alternatively be expressed as preferences) may include those such as the following: (i) a buyer will accept any k of a set of n shows in the campaign; (ii) minimum and maximum volumes (in units or monetary values) at various temporal and other scopes; (iii) sequence-based constraints, such as sequentially ordered advertisements; (iv) a requirement that advertisements be placed as complementary advertisements (e.g., ad1 on show X, ad2 on show Y; will pay in 1:2 ratio); or (v) counting constraints, (e.g., 8 programs of interest, but will only pay for ads on at most 4 programs). Thus, in various embodiments the system may enable the buyer to identify the different monetary values by expressing preferences over targeting (how much the buyer is willing to pay for various values of the attributes and/or combinations of the attributes) and/or campaign control features (how much the buyer is willing to pay for various campaign control features or combinations thereof).

The system may also allow the buyer to select whether a campaign can be accepted partially or not. In the latter case, the system may require a user to accept a campaign entirely or not at all, and if so this constraint may be included in the optimization model that is used for decision making (discussed in detail later).

The system may also allow the buyer to select whether a campaign has to be guaranteed (to execute according to its specification) or not. A non-guaranteed campaign provides the seller more flexibility in the optimization, and the seller may thus be willing to sell a non-guaranteed campaign at a lower price than the same campaign with a guarantee. In one embodiment, the buyer and/or seller further specifies how meeting the guarantee is measured. One typical default setting would be that all of the campaign's constraints, including quantity delivered (or reach defined in some other way) and budget, are satisfied. As shown, some fields (such as campaign title field 201) may be free-form input fields that accept characters entered by a user. Other fields may include drop-down menus or other mechanisms by which users may select an option from various available options. Examples include the smoothness fields 204 and fields for exclusivity criteria 205. Optionally, the system may select and include some of the options available in any drop-down on a dynamic basis, based on user selections in a previous field and/or stored buyer profile information. For example, an exclusivity field for a buyer whose profile categorizes the buyer as a fast food restaurant may present a list of exclusivity options that include other entities in the same category (fast food restaurants in general), or specific restaurants or restaurant groups that would be competitors to the buyer. Also, the user interface may allow the advertiser to select which industry or industries the advertiser belongs to for purposes of declaring exclusivity to entire industries, or for purposes of helping to narrow down the list of particular competitors to choose for this in the user interface. As another example, if the buyer's profile indicates that the buyer has previously purchased advertisements targeting viewers in a particular geographic zone, it may present that zone as a default value in a field through which the user may enter a geographic criterion.

Optionally, some input fields may include indicators as to whether a selected criterion is a constraint (i.e., a requirement) or a preference (meaning that the buyer would like the criterion to be met, but it is not a make-or-break requirement). For example, an exclusivity criterion selector may include a preference selection interface 206 by which the system may receive a user's categorization of the criterion as either a constraint (i.e., a requirement) or a preference.

In some embodiments, the system may permit an advertiser/buyer to express different monetary values for different campaigns. More generally, the advertiser may even be able to express monetary values for what campaigns other advertisers get and do not get. An advertiser may express monetary values for different ways that the media units are allocated among the advertisers (and some of them may be kept by the seller, for example to reduce advertising fatigue by viewers or to do marketing of the media provider itself).

In one embodiment, the advertisers express such monetary values in the form of preferences and constraints. The preferences and constraints can be on attributes associated with, for example, targeting and/or campaign control. An example of a targeting criterion is an audience targeting criterion such as “I will only pay for female viewers, and I will pay $2 CPM (i.e., cost per thousand views),” and it can be combined with preferences such as “I will pay $5 CPM for female viewers in California, I will pay $7 CPM for female viewers who earn more than $60,000 annually, and I will pay $16 CPM for female viewers in California who earn more than $60,000 annually.” Examples of campaign control criteria include expressions of reach, frequency, smoothness, exclusivity, and placement within an advertising pod (such as first in pod, second in pod, . . . last in pod), bookends (first and last in pod), sandwich (this advertiser's advertisement followed by someone else's, followed by another one from this advertiser), piggybacks (two advertisement slots for the same advertisers back to back), and roadblocks (same slot in multiple shows at the same time, etc.). For example, a constraint can state that the reach has to be at least x, and it can be combined with a preference such as “I will pay $50,000 more if the campaign's flow varies by at most 10% across days within the flight of the campaign, or I will pay $70,000 more if the campaign's flow varies by at most 5% across days within the flight of the campaign.”

In general, within such preference expressions the space of different trigger conditions may be combinatorial in the number of attributes as the above targeting example shows, and can thus be cumbersome with large numbers of attributes. Therefore, the system may permit various restrictions on which combinations can be included in the trigger conditions to be added or used in order to simplify the expression of preferences.

In one embodiment, the user specifies base pricing and a list of bonuses, each with its own trigger condition (or conditions). The triggered bonuses are then summed up and added to the base pricing to come up with the user's expression of value for the campaign. For example, the base pricing can be “I will only pay for female viewers, and I will pay $2 CPM” and the list of bonuses can include “I will pay $2 CPM more for viewers in California” and “I will pay $5 CPM more for viewers who earn over $60,000 annually.” Both the base values and bonuses can be absolute numbers or variables that can depend (linearly such as CPM, piecewise linearly, or nonlinearly) in the volume of units awarded or delivered to the campaign. Furthermore, there can be restrictions on how the bonuses can be combined or how much they can amount to overall. In one embodiment these could come from the buy side but they could also come from the sell side.

As an example, if the system receives a user's categorization of two or more of the purchasing criteria as preferences, along with a bonus amount that the first buyer will pay if the preference is satisfied in the advertising campaign and a constraint on how the bonus amounts may be aggregated, then when developing the advertising campaign the system may do so such that the advertisements are distributed among the time units for media assets in order to satisfy the criteria that are categorized as preferences. It may also determine a cost for the campaign that includes the bonus amounts as limited by the constraint.

Optionally, the preference selection interface 206 also may include an input by which the system may receive a user's identification of a bonus value (i.e., an amount above a base level, or an alternate base monetary value) that the buyer will pay if the campaign satisfies the preference. A bonus value may be expressed in terms of a numeric value, a percentage, an equation, or a rule that indicates how the bonus will increase as various preferences are cumulatively satisfied in the delivered ad campaign.

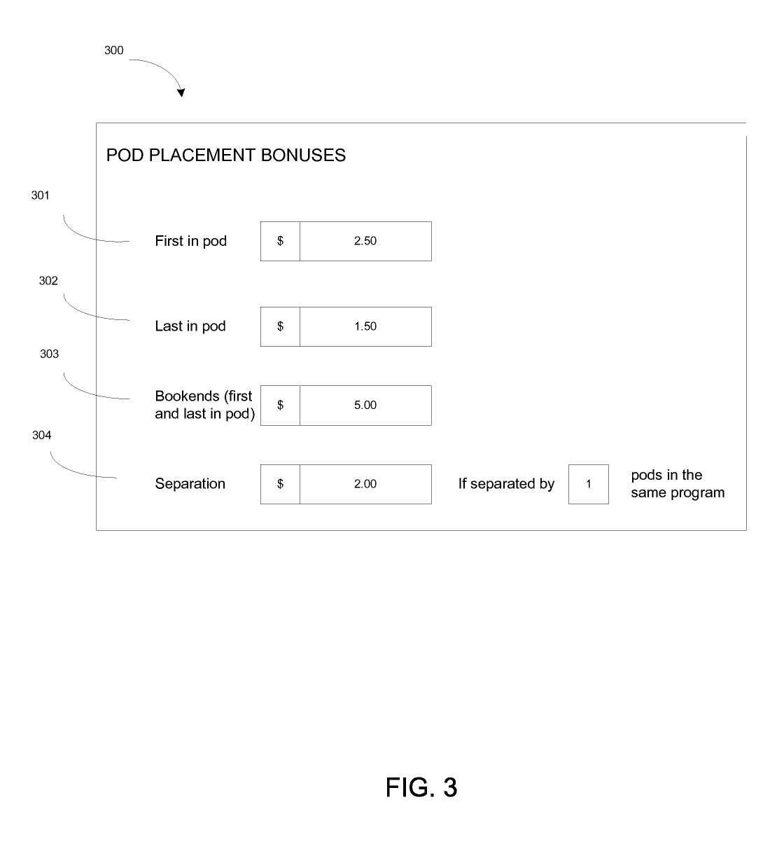

In addition, the system may include an interface by which a user may specify varying bonus values for different criteria. An example of this is shown in FIG. 3, which shows an interface portion 300 wherein the system may receive a set of various user-selected bonus values 301-304 if the advertisement is placed at various positions in a pod or a group of pods. Fields such as these may allow the user to express a preference for one or more slots in an advertising campaign.

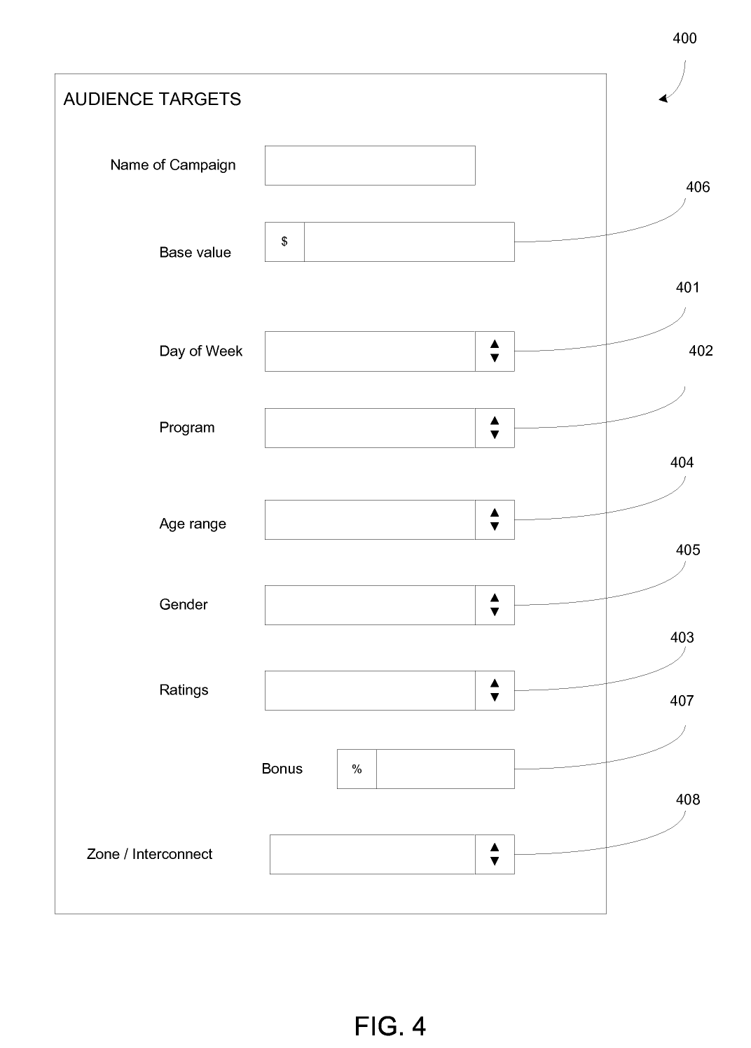

FIG. 4 illustrates another buyer user interface portion 400 in which the system may receive user-specified target audience criteria. The fields for receiving the criteria may include fields for criteria such as temporal criteria 401-402 and non-temporal criteria 403-405 and 408. Temporal criteria may include criteria relating to the position at which one or more ads will be placed, such as a position within a pod, a particular media asset 402, and/or a particular day 401. Non-temporal criteria may represent desired attributes of programs in which advertisements will be placed, such as historic or actual ratings for the program 403, genre, parental guidelines, a channel or network that is presenting the program, and other attributes. Non-temporal criteria also may represent desired attributes of the audience who views the program, such as age range 404, gender 405, income, and the like. Additional target audience criteria may include criteria that one or more of the viewers for the media asset, advertisement or campaign have purchased a specified good or service within a specified time period, criteria that one or more of the viewers have exhibited a particular viewing pattern over a time period. Additional target audience criteria may include a requirement that one or more of the viewers have expressed positive feedback on a social networking service for a media asset in the campaign, such as by liking, sharing, or otherwise expressing positive feedback about a program on a social media service, or a requirement that a viewer has not publicly expressed negative feedback on a social network for a media asset in the advertising campaign. Other target audience criteria are possible.

In some embodiments, the number or types of audience attributes and other criteria that a user may specify may be unlimited or virtually unlimited. For example, the system may provide a large set of attribute categories to the user, and in some embodiments it may permit a user to define new attributes for use in new campaigns. Optionally, the system may permit the system to define any such criteria on a per-program basis or on a cumulative, multi-program (i.e., cross-show) basis.

Optionally, the fields for receiving target audience criteria may include fields for financial criteria such as a base value 406 for the purchase of some or all of the campaign, and a bonus value 407 representing an additional amount above the base that the buyer will pay if all or a specified portion of the criteria (e.g., ratings) are satisfied. A bonus value may be expressed in terms of a numeric value, a percentage, an equation, or a rule that indicates how the bonus will increase as various preferences are cumulatively satisfied in the delivered ad campaign.

Optionally, the constraints (and preferences) can also include criteria 408 such as a specified zone or interconnect (i.e., a group of zones) within which the buyer desires the advertisements to be presented to viewers. For example, the optimizer can employ a constraint that if a slot is allocated to an interconnect-level campaign, then the advertisement has to run in that same slot (i.e., same time) in all zones belonging to that interconnect. This constraint can be relaxed in several ways, such as requiring only a certain number of zones within the interconnect to run that advertisement in that slot.

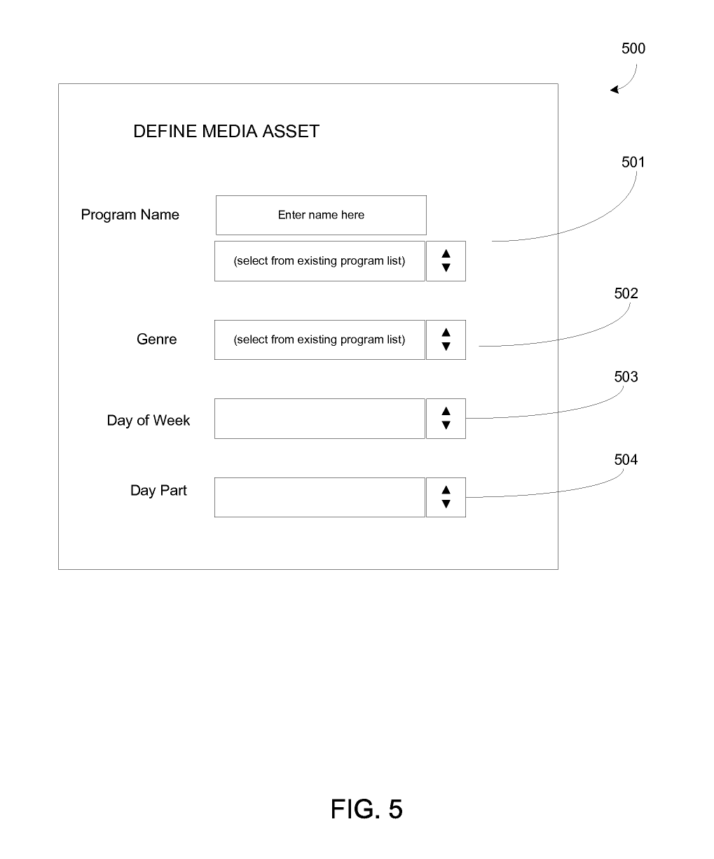

FIG. 5 illustrates an example of a section of a media asset manager user interface 500 by which the seller may enter various attributes for a media asset such as a television show. The seller may use this interface 500 to define and add temporal attributes 503-404 and other, non-temporal attributes 501-502 for new programs and other media assets to the database so that the media assets and associated data can be used in future advertising campaigns. This interface also may permit a seller-user to modify attributes of existing programs in the database.

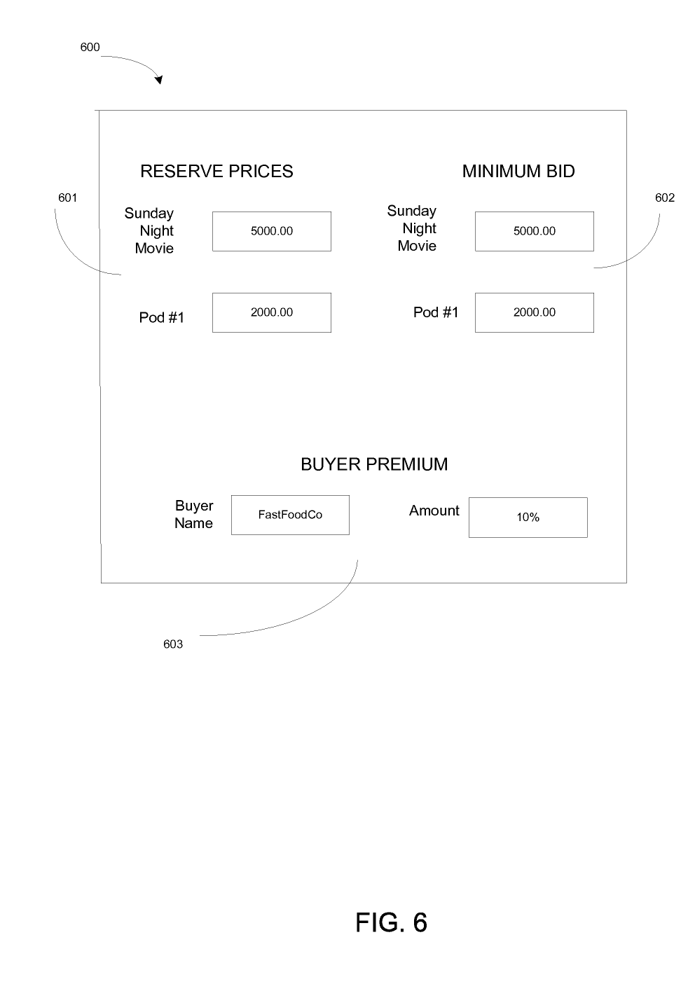

The media asset manager user interface also may include one or more sections that permit a media service provider or its representative to identify seller-side criteria for assets or campaigns. For example, as shown in FIG. 6, such as interface 600 may include fields wherein the system may receive user-specified reserve prices 601, minimum bids 602 or other financial criteria for the placement of advertisements within various media assets. The interface also may include fields that allow the seller to add a premium value 603 to bids or budgets received from a particular buyer (for example, to favor the bidder in the allocation optimization), a requirement to provide a particular buyer with audiences having specified attributes (plus a quantity to provide, such as a minimum quantity), a rule to factor in a make-good cost when developing the advertising campaign for a particular buyer, and other criteria.

Furthermore, reserve prices do not have to be only on individual items: there can be reserve prices on bundles (campaigns). The seller can use reserve prices to represent the value of the inventory in the future. In one embodiment, in the optimization the system maximizes revenue, viewing the reserve prices as campaigns that the optimizer can accept. If a reserve campaign (on an item or bundle) wins, that means that the seller keeps the corresponding inventory unsold currently, in anticipation of better sales opportunities in the future.

The system also may support bundling of sales units, meaning that they have to be sold together or not at all. This may help revenue, especially if competition is thin.

Optionally, the seller can include seller-side criteria that incorporate its own marketing campaigns into the optimization by specifying them as zero-budget campaigns (with potentially a variety of constraints as in other campaigns) but including a constraint that they must be fully satisfied. This approach can also be used to represent prior commitments made to buyers, for example, commitments made outside the system in manual negotiations. This option enables a manual sales/automated sales hybrid.

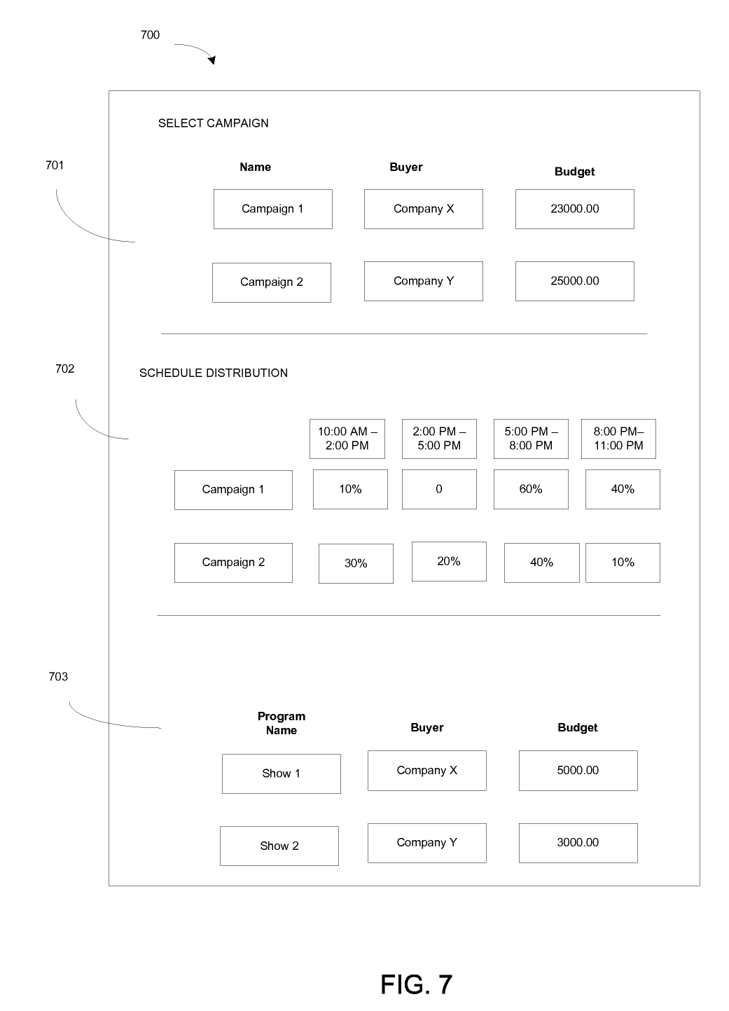

Referring to FIG. 7, the system also may include one or more scheduling interfaces 700 by which the system presents to a user various characteristics of accepted and/or requested campaigns. The system may provide this as a scheduling interface by which a user may view reports of each campaign 701, and view and optionally modify various characteristics of a campaign such as the distribution of a particular campaign's advertisements over particular units of time 702 or which campaign is the winning bidder for (i.e., has been assigned) a particular slot of a media asset in the schedule 703. The scheduling interface also may include fields by which a user may enter: (i) campaign control constraints on behalf of the buyers, such as smoothness; (ii) seller-side constraints and preferences as in a sales and allocation setting; and/or other criteria.

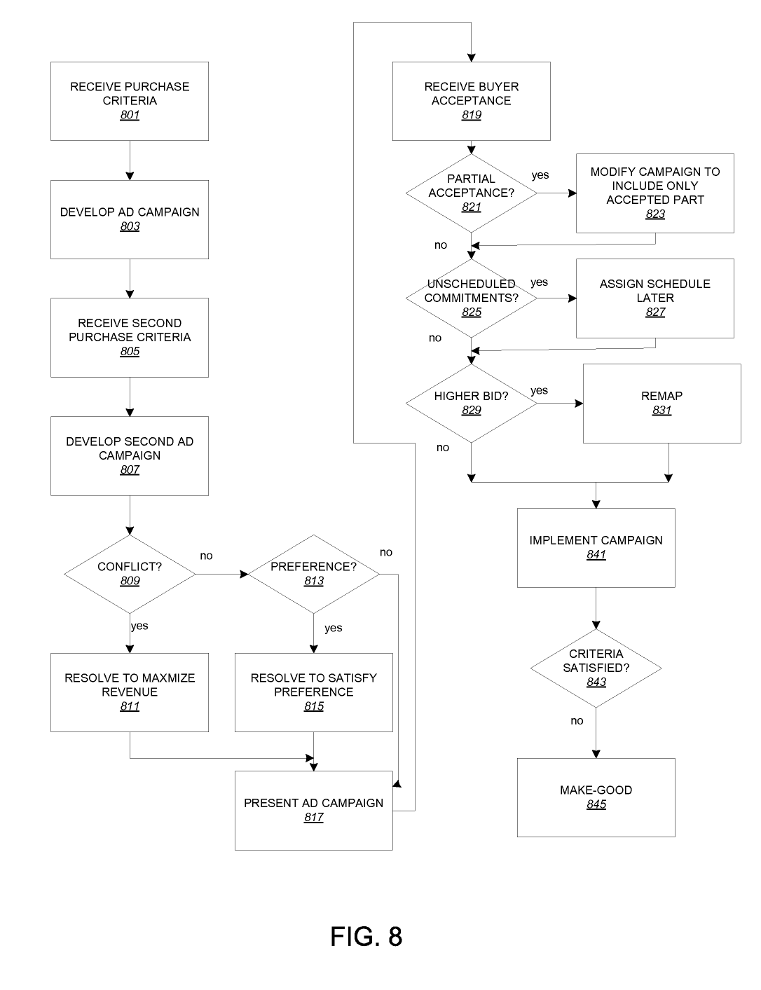

FIG. 8 is a flowchart illustrating an example process of building advertising campaigns. In this example, an advertising campaign manager will receive a buyer's purchasing criteria for a purchase of advertisements in a media service (step 801). The criteria may include a set of temporal parameters, program attributes, and/or placement requirements or restrictions that the buyer desires its ad placements to satisfy. Example criteria may include any of those discussed above, such as budget criteria, which may include a minimum and/or maximum budget for an individual ad, a group or ads or an entire campaign. The criteria may be received from the buyer or another person via a user interface, or the criteria may come from other sources such as stored data sets, web service calls or data feeds.

In addition to, or instead of, getting constraints and preferences directly from users, in some embodiments the system may leverage a user interface or other tool that suggests what the buyer's preferences should be (based on, for example, historical viewer responses or what media assets the advertiser has bought in the past). For example, that tool could provide answers to questions like “how broadly should a particular business target?” The answers can serve as input (constraints and preferences in campaign requests) in the system.

Optionally, the system may enable a user to designate (or it may otherwise receive a designation of) any purchasing criterion as a constraint, meaning that the system must not schedule an ad unless the scheduling meets the required purchasing constraint. The system also may enable a user to designate any purchasing criterion as a preference, meaning that if multiple possible placements would satisfy other criteria then the system should give preference to those placements that also satisfy the preferred criteria. In some embodiments, the preferences take the form of expressions of monetary value, so they will automatically be taken into account in the optimization through revenue maximization.

The system may then use the purchasing criteria and the temporal parameters in the database to automatically develop an advertising campaign for the buyer (step 803). The advertising campaign will include a set of media assets in which advertisements will be placed for the buyer, along with the scheduling parameters indicating when the advertisements will run within each program. The system may do this using any suitable algorithms, such as those that require the selection of ad placement characteristics (i.e., programs and schedule parameters) that: (i) satisfy each constraint in the purchasing criteria; (ii) satisfy at least a threshold number or percentage of the constraints in the purchasing criteria; (iii) minimize some constraint relaxation cost function; (iv) maximize revenue minus a constraint relaxation cost function; or (v) have purchase price attributes that, in total, meet the budget criteria in the purchasing criteria. The system may then present the ad campaign to a user (step 817) for review, approval, and/or modification. In the context of this discussion and the associated claims, the term “ad campaign” or “advertising campaign” is intended to cover embodiments that include an entire campaign as well as embodiments where the system analyses, selects and presents various elements of a campaign (such as individual advertisements, subsets of all ads in a campaign, or particular programming or time blocks). Here an advertising campaign can be also defined at a level of abstraction so it may be instantiated onto specific media units later in alternate ways. For example, when a buyer places a campaign request for sports, the campaign can be basketball in California without specifying exactly which slots within which pods are going to be part of the campaign.

As examples, if the system receives a start time, end time, duration, a requested slot or other temporal criteria for the buyer's campaign along with a budget constraint, it may develop the advertising campaign to satisfy those criteria. If the system receives a smoothness criterion and a time unit for the smoothness criterion (where the time unit is a subdivision of the campaign's overall time period), it may develop the campaign so that advertisements are distributed among the time units for the media assets, such as scheduled television programs, in a manner that does not violate the smoothness criterion. If the system receives a separation criterion for a buyer's campaign, it may develop the campaign so that the buyer's advertisements and placements of ads of a user-specified type are positioned in a manner that does not violate the separation criterion. If the system receives a geographic criterion such as a requested zone or interconnect, it may develop the campaign so that advertisements will be presented to consumers who are located in places that satisfy the geographic criterion. In some embodiments, the system also may receive one or more seller-side constraints, such as premium values to be assigned to particular buyers, reserve price or minimum bid restrictions, a requirement that certain campaigns be accepted regardless of the budget, or a rule to factor in a make-good cost in a revenue analysis when developing the campaign. Seller-side criteria also may include a requirement to provide a buyer with an audience having certain attributes (and/or quantity). Such an embodiment provides a way to include commitments that have been negotiated outside the system into the optimization system rather than having to earmark specific inventory for those commitments, so that the system will decide what inventory is best to use to satisfy those prior commitments in light of all campaigns, campaign request, state of execution of campaigns, supply, demand, supply projections, and demand projections). If the system receives such seller-side criteria, then it may develop the campaign to satisfy the seller-side constraints or other seller-side criteria.

When selecting the set of media assets for inclusion in the advertising campaign, it may be the case that multiple candidate media assets have temporal and/or non-temporal attributes that meet the buyer's budget criteria and other required purchasing constraints. If so, then the system may select, from the candidate set of media assets, a subset of the assets that maximizes a revenue opportunity for the media service provider while remaining within the buyer's budget criteria. By maximizing a revenue opportunity, the system does not necessarily need to always guarantee that the media service provider will yield the highest possible return. However, at a minimum the phrase “maximizing a revenue opportunity” in this document means that when presented with two or more options, the system will select the options that yields the highest revenue among the options, or that yields the highest revenue so long as the campaign also satisfies other buyer or seller criteria, or at least not the lowest revenue among the available options. The system may do this using any suitable process.

For example, if a buyer has identified a target audience criterion and a bonus amount that the buyer will pay if the advertising campaign delivers an audience that satisfies the target audience criterion, it will give preference to developing the campaign so that it will yield the bonus amount. As an example, if a first buyer designates a particular slot as bonus-eligible and no other buyer bids a higher amount for that slot, it may assign an advertisement for the first buyer to the designated slot. Thus, the system may perform at least preliminary slot-level scheduling as part of the revenue optimization process, before the buyer actually needs to commit to purchasing the a campaign.

Similarly, if the first buyer designates an exclusivity preference, such as one that includes an exclusive time period and a competitive restriction, it may determine whether developing the campaign to satisfy the preference would maximize a revenue opportunity for the media service provider and if so, it will develop a campaign for a second buyer in a way that does not violate the first buyer's exclusivity preference.

An example of a suitable optimization process is use of a linear or non-linear mixed integer program (MIP). With the MIP, variables can be specified such as binary variables indicating whether or not a campaign is accepted, or real variables representing to what extent a campaign is accepted and/or rejected. The MIP will receive an objective that is to be maximized (i.e., revenue), and constraints and preferences, to solve the issue of winning bid and ad placement. Alternative algorithms may include branch-and-bound, branch-and-cut, branch-and-price, local search, simulated annealing, genetic algorithms and the like.

Alternatively or in addition to sheer revenue maximization, alternative objectives can be used in the optimization program. For example, forms of robust optimization, stochastic optimization, or quadratic optimization can be used to determine solutions that are robust to risk, such as demand and/or supply fluctuations. As an example, the system may choose an allocation that will give high value and low makegoods under various uncertain scenarios (ratings variations, lineup changes, etc.). Any suitable optimization techniques for robust, stochastic, and quadratic optimization may be used in this process. Such risk can also be mitigated through additional constraints in the optimization model.

To determine or discover prices or quotes for campaigns or portions of campaigns, the system may perform a computation such as the following: One wants to know what price a given campaign would have to offer to be accepted. The system may try different prices (e.g., using binary search) and run the optimizer (with all the information about all the other campaigns, etc.) for each price to narrow down the price point at which the campaign changes from rejectable to acceptable. Another way to do this determination is to force the campaign to be accepted (via a constraint) while having zero price, and seeing how much the overall allocation revenue drops. The drop is the amount that the campaign would have to pay to become acceptable.

Optionally, the system may automatically resolve, or it may help a user resolve, conflicts between multiple potential buyers and determine how best to create multiple advertising campaigns that avoid overlapping ad commitments. For example, if the system receives a second buyer's purchasing criteria for second buyer's ad campaign (step 805), the system may use the second buyer's purchasing criteria and the temporal parameters in the data set to develop a second advertising campaign for the second buyer (step 807). The second campaign will includes a second set of media assets, a second set of advertisements for the second buyer, and temporal parameters for each advertisement in the second set.

If the system determines (step 809) that the first advertising campaign and the second advertising campaign include a common ad placement for a particular media asset (i.e., commitments to air two ads at the same time), and if one of the ad placements will maximize a revenue opportunity for the seller (step 810), then the system may resolve this conflict (step 811) by determining which ad placement of the first and second advertising campaigns will maximize a revenue opportunity for the media service provider, including the common ad placement in the advertising campaign that will maximize the revenue opportunity for the provider, and modifying the other advertising campaign by replacing the common ad placement in the other advertising campaign with a different ad placement that meets the purchasing criteria for the other advertising campaign's buyer (step 817). Suitable methods of determining which campaign will maximize a revenue opportunity are discussed above.

Alternatively, or if the revenue opportunities are substantially equal for both options, then the system may determine whether resolving the conflict in favor of one campaign or the other will satisfy one of the potential buyers' preferences (step 813). If so, then the system may resolve this conflict (step 815) by determining which of the first and second advertising campaigns will best satisfy a buyer preference, include the common ad placement in the advertising campaign that will best satisfy the buyer preference, and modify the other advertising campaign by replacing the common ad placement in the other advertising campaign with a different ad placement that meets the purchasing criteria for the other advertising campaign (step 817).

After the buyer accepts the campaign, the system may then cause it to be implemented on the media service 841. It may do this by assigning advertisements to multiple media assets that are presented on multiple media, such as broadcast television, cable television, on-demand television, online streaming media, downloadable media, and the like. For example, the system may distribute ads so that they are assigned to positions in at least a television program and an on-demand program that is distributed via an online video distribution service. Optionally, in some embodiments it may distribute the advertisements among multiple services, so that a single advertising campaign includes ads that are distributed among multiple sellers. The system may do this automatically, or it may transfer rules, templates, files and/or data sets to the media service provider so that the provider may do it.

In some embodiments, the system may receive a buyer acceptance 819 of a campaign with an indicator that the buyer is only willing to accept a part of the campaign 821. If so, the system may automatically modify the campaign to only include the accepted part 823. The modification may include developing and presenting new pricing attributes for the campaign to the user, in which case the user may be given the opportunity to accept or reject the modified campaign, and potentially provide additional constraints and preferences As a special case of this process, the accepted part can be empty, in which case the system can suggest a new campaign.

In some embodiments, the system may develop campaigns to permit flexible scheduling of advertisement/media asset assignments. For example, when developing a campaign, the system may preliminarily assign any or all of the advertisements of a campaign to particular positions (i.e., to particular media assets, or to particular temporal positions associated with one or more media assets) in the campaign. However, the system may not present all of the assignments to the first buyer as commitments to schedule an ad a particular position. Instead, at least some of these preliminary assignments may be treated and presented as unscheduled commitments 825 that will be assigned or confirmed at a later time 827. An unscheduled commitment is one in which the buyer is not guaranteed that a particular ad will be allocated to a particular position or scheduled at a particular time, but instead the seller retains flexibility to allocate, reallocate or reassign the ad in the future. This may happen if, for example, multiple media assets have attributes that will meet the buyer's criteria. If so, then the system can assign advertisements to media assets or temporal positions after it has more information to determine which assignments will maximize a revenue opportunity for the media service provider, such as after it receives other campaign requests from other buyers, or refined supply and/or demand projections. As an example, if a campaign request from another buyer includes a higher bid for the placement of an ad in a particular slot 829, the system may remap 831 the first campaign to move an ad from its temporary position (e.g., the particular slot) and into another position that satisfies the first campaign's buyer criteria so that the higher-bidding buyer can be awarded the particular slot. When doing remapping 831, the system also may re-optimize the first campaign to determine which new position, media asset association, or other configuration of the ad in the campaign will maximize the revenue opportunity for the media service provider.

Remapping can be motivated and triggered by any event, such as a new campaign request arriving or supply or demand projections changing, or even a certain time passing with nothing unplanned happening.

In remapping the system may reoptimize what ad inventory gets allocated to what campaigns. Scheduling decisions can be included among those allocation decisions, but don't have to be. The decision variables can be at abstract levels (e.g., do we allocate basketball or golf programming to a particular campaign) or fully concrete (e.g., what exact slots are allocated to what campaigns).

In this reoptimization, the system could take any or all of the following considerations into account if available: execution state of existing campaigns; campaign commitments made so far (which can be abstract so as to retain flexibility to remap); those preferences that are still valid in accepted campaigns; new campaign requests; projected supply; or projected demand.

Furthermore, in this process of leaving commitments intentionally abstract to be able to remap the inventory to accepted campaigns better to make profitable room for additional campaign requests, it does not have to be the scheduling aspects that are left uncommitted. Any aspects of a planned campaign can be declared to the buyer as commitments or left open so as to retain flexibility. For example, the optimizer may have in its plan that specific quantities of specific shows are going to be used to satisfy a campaign, but the buyer is only told some more high-level characterization of that set. For instance, instead of committing to the buyer that the specific planned baseball games will be allocated the buyer, the seller can commit to delivering “premium golf, premium basketball, or any yachting shows” to fulfill the campaign.

The system can be used to reoptimize the allocation in light of new campaign requests, changes in supply (and/or supply projections), and changes in demand projections (represented in the system, for example, via updated reserve prices or reserve campaigns).

Reoptimization may be essentially the same as the optimization described above, except that the campaigns have execution state, which affects what is the best way to fill them with what inventory going forward. For example, a campaign can have an amount delivered so far, which affects how much is still needed to satisfy the campaign commitment. Similarly, the campaign may have executed at a certain volume of advertisements per day so far, which affects how much per day is required and profitable to give to that campaign to satisfy the smoothness constraint that ties the past execution to the future execution.

As in the optimization, reoptimization may take the preferences into account from not only the new campaign requests but also from the previously accepted campaigns. In some embodiments some of those preferences may long be valid, such as some bonus offers that did not get accepted when the campaign was first accepted may no longer be considered to be on offer from the buyer. In the reoptimization, some existing campaigns may get remapped onto the inventory differently than they were mapped before.

Reoptimization can be initiated automatically (e.g., periodically or when supply and/or demand and/or execution state and/or campaign requests have changed sufficiently from projections or from a previous state) or manually.

In some embodiments, during or after implementation of the campaign 841, the media service provider may determine that it is unable, or will likely be unable, to satisfy (profitably or at all) all of the buyer's purchasing criteria 843. Examples of this may occur when a scheduled program is pre-empted by a news bulletin or by an earlier live program that ran over its scheduled time, or when a video-on-demand service failed to deliver the entire program due to a communication service error, or a show has been canceled, or the gross rating points (GRPs) which indicate viewership were lower than predicted. If so, then it may determine a make-good action and cause the make-good action to be automatically offered and/or provided to the buyer 845. An example of such an action is automatically allocating additional advertising unit inventory that has a value equivalent or higher than the failed part of the originally allocated inventory, and which also satisfies the buyer's criteria. In one embodiment, a reoptimization is initiated that optimizes the decisions of accepting campaign requests (if any) and scheduling existing campaigns and the newly-accepted campaigns, holistically to maximize revenue, taking into account the monetary loss from makegoods (which is typically the cost of giving away future inventory for free, but can be some other cost such as an explicit penalty payment or reputation cost). In other words, this is optimization of makegoods. This is done in light of the execution state of campaign, projected supply (inventory in the various inventory segments), and demand projections (if available).

In some embodiments, when the system develops an ad campaign, it may present one or more alternatives to a user for consideration. For example, the system may permit a user to specify, or it may automatically identify, an alternate criterion that is an alternate or supplement to at least one of the buyer's purchasing criteria. If so, it may use the temporal and non-temporal attributes in the data set to develop an alternative advertising campaign that satisfies the buyer's purchasing criteria as modified by the alternate criterion. It may then present the alternate campaign to the user for consideration and selection. Examples of such constraints may include undersell constraints that restrict the sale of ads for a particular media asset or slot or other unit of inventory within a media asset. Another example is an oversell constraint that permits assignment of conflicting advertising commitments for a particular media asset or slot or other unit of inventory within the media asset. If so, then the system may automatically generate a report to the media service provider that identifies any conflicting commitments.

The system also support various forms of sensitivity analysis. For example, the seller may be able to conduct sensitivity analysis using what-if analysis of changing sell-side constraints, preferences, and hard-wirings (which are actually a form of constraint), and then rerunning the optimizer to see how the revenue and allocation would change.

As another example, a user may be able to have the system perform a sensitivity analysis by forcing undersell (e.g., saving some inventory to be sold in the future). This tells the user the tradeoff between quantity left to be sold in the future (or used for other purposes such as self marketing) and revenue. This sensitivity analysis can be done by putting the undersell constraint overall, or on a per-inventory-segment basis, and to different extents.

As yet another example, a user may be able to have the system perform a sensitivity analysis by allowing oversell. This sensitivity analysis can be done by relaxing the supply constraints throughout on a per-inventory-segment basis, and to different extents. For one, this will tell the seller what inventory would be most valuable to have more of. The seller can use this information to generate or procure more content of those kinds. The system may then provide the seller with a report of each conflicting commitment resulting from the oversell. The report may include one or more characteristics of each campaign, such as revenue that it will generate, so that the seller can use the reported information to decide which campaign will win the conflict and which will be reallocated.

In some embodiments, the system may include a seller-side user interface as described above. The seller-side interface may permit a user to enter a modification to a presented advertising campaign. This can be used, for example, for manual (instead of optimized) sales. A manual/automated hybrid is another option here. The seller can, for example, use mainly manual sales in the beginning when most inventory still available, and automated packing of campaigns onto remaining inventory later on in the process when supply is tighter.

The seller might include campaign control constraints on behalf of the buyers, such as smoothness. The seller can include sellside constraints and preferences as in the sales+allocation setting. The seller could include other objectives as in the sales and allocation setting. The seller could do a what-if analysis as in the sales and allocation setting.

If the system develops an alternate campaign, it may present the alternate campaign to a user to review, accept, and/or request to modify.

In some embodiments, the methods and systems described in this document can be used in a mode where all campaign requests are available at the same time (i.e., a batch mode), or in a mode where campaign requests arrive over time and have to be awarded or rejected before all campaign requests have arrived (i.e., a dynamic mode). The sales tool can also be used as a sales support tool, where the buyers do not necessarily even know that the seller is entering the buyer's campaign requests into the system, and the system is making campaign suggestions to the seller's sales executives.

When per-advertising-unit pricing is discussed in this application, it can be based on any metric, such as number of slots, slot time, number of impressions, number of clicks, purchases, other viewer actions, and so on. All of these metrics can be weighted by quality. Furthermore, a combination of different metrics can be used in the system, and even within one campaign, e.g., I will pay $5 CPM plus $0.50 per click.”

In some embodiments, the system and approach can also be used when there are multiple sellers, and a buyer's campaign can potentially runs across the inventories of the different sellers. One skilled in the art of mechanism design game theory will appreciate that there are a myriad of alternate ways to divide the revenue among the sellers. Those different mechanisms can have different impacts on the incentives of the participants in the system. Another factor that may be considered in the multi-seller setting is what happens if a campaign fails: i.e., which sellers are at fault and how (and how much) does each seller have to make good. One way that the system may handle this is to bilateralize all the campaigns or commitments so a multi-way commitment is split into multiple commitments between the buyer and one seller each. However, this removes some flexibility from reoptimization if one mandates that one can only reoptimize within each bilateral commitment.

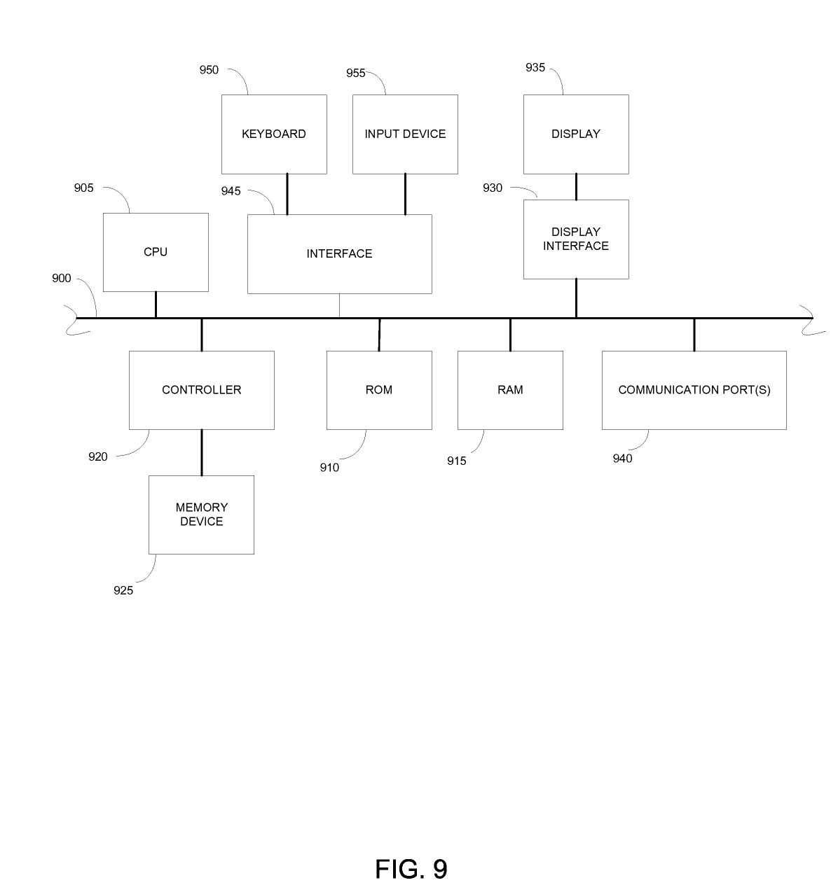

FIG. 9 depicts an example of internal hardware that may be used to contain or implement the various computer processes and systems as discussed above. An electrical bus 900 serves as an information highway interconnecting the other illustrated components of the hardware. CPU 905 is a central processing unit of the system, performing calculations and logic operations required to execute a program. CPU 905, alone or in conjunction with one or more of the other elements disclosed in FIG. 9, is a processing device, computing device or processor as such terms are used within this disclosure. Read only memory (ROM) 910 and random access memory (RAM) 915 constitute examples of memory devices.

A controller 920 interfaces with one or more optional memory devices 925 that service as data storage facilities to the system bus 900. These memory devices 925 may include, for example, an external DVD drive or CD ROM drive, a hard drive, flash memory, a USB drive or another type of device that serves as a data storage facility. As indicated previously, these various drives and controllers are optional devices. Additionally, the memory devices 925 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 910 and/or the RAM 915. Optionally, the program instructions may be stored on a tangible computer readable medium such as a compact disk, a digital disk, flash memory, a memory card, a USB drive, an optical disc storage medium, a distributed computer storage platform such as a cloud-based architecture, and/or other recording medium.

When used in this document, the term “processor” can refer to a single processor or to multiple processors that together implement various steps of a process. Similarly, a “memory device” or “database” can refer to a single device or databases or multiple devices or databases across which programming instructions and/or data are distributed.

A display interface 930 may permit information from the bus 900 to be displayed on the display 935 in audio, visual, graphic or alphanumeric format. Communication with external devices may occur using various communication ports 940. A communication port 940 may be attached to a communications network, such as the Internet, a local area network or a cellular telephone data network.

The hardware may also include an interface 945 which allows for receipt of data from input devices such as a keyboard 950 or other input device 955 such as a remote control, a pointing device, a video input device and/or an audio input device.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A system for managing media advertising campaigns, comprising:
a set of programming data comprising temporal attributes and non-temporal attributes for a plurality of media assets that a media service provider will present to consumers;
a processor; and
a computer-readable medium containing programming instructions that, when executed, cause the processor to implement a media advertising campaign manager by:
causing an electronic device to implement a user interface that displays a plurality of user-selectable purchasing criteria for advertisements to be placed in one or more of the media assets,
receiving, via the user interface, a selection of one or more of the purchasing criteria for a purchase of advertisements by a first buyer,
using the temporal attributes and non-temporal attributes in the data set to automatically develop an advertising campaign for the first buyer that satisfies the selected purchasing criteria, and
presenting indicia of the advertising campaign to a user to review.

2. The system of claim 1, wherein:
the instructions to present the user interface that displays a plurality of user-selectable purchasing criteria comprise instructions to:
enable the user to identify a start time, end time or duration for the advertising campaign, and
enable the user to identify a budget constraint for the advertising campaign; and
the instructions to implement the media advertising campaign manager comprise instructions to develop the advertising campaign so that it satisfies the budget constraint and the identified start time, end time or duration.

3. The system of claim 1, wherein the instructions to present the user interface that displays a plurality of user-selectable purchasing criteria comprise instructions to enable the user to:
identify one or more alternative criteria for the campaign;
identify one or more different monetary values that the buyer will pay if any of the alternative criteria are met.

4. The system of claim 3, wherein the instructions to present the user interface that displays a plurality of user-selectable purchasing criteria comprise instructions to enable the user to:
identify the different monetary values by expressing preferences over targeting, campaign control criteria or both.

5. The system of claim 1, wherein the received selection of one or more of the purchasing criteria comprises a target audience criterion that comprises at least one of the following:
a requirement that a viewer have purchased a specified good or service within a time period;
a requirement that a viewer have exhibited a viewing pattern over a time period;
a requirement that a viewer has publicly expressed positive feedback on a social network for a media asset in the advertising campaign; or
a requirement that a viewer has not publicly expressed negative feedback on a social network for a media asset in the advertising campaign.

6. The system of claim 3, wherein:
at least one of the alternative criteria comprises an exclusivity preference that comprises:
an exclusive time period, and
a competitive restriction for the placement of advertisements by a second buyer in one or more of the media assets during the exclusive time period; and
the instructions to automatically develop the advertising campaign comprise instructions to:
use the different monetary value for the exclusivity preference to determine whether satisfying the exclusivity preference will maximize a revenue opportunity for the media service provider, and
if satisfying the exclusivity preference will maximize a revenue opportunity for media service provider, then develop an advertising campaign for the second buyer so that media assets of the second buyer are positioned in a manner that does not violate the exclusivity preference of the first buyer.

7. The system of claim 1, wherein:
the instructions to present the user interface that displays a plurality of user-selectable purchasing criteria comprise instructions to enable the user to:
identify an overall time period for the advertising campaign,
define a time unit that is a subunit of the overall time period, and
identify a smoothness criterion that represents a measurement of a maximum amount of change in a volume of advertisements allocated to each of the time units for the advertising campaign; and
the instructions to automatically develop the advertising campaign comprise instructions to develop the campaign so that the advertisements for media assets that are scheduled television programs are allocated to the time units in a manner that does not violate the smoothness criterion.

8. The system of claim 1, wherein:
the instructions to present the user interface that displays a plurality of user-selectable purchasing criteria comprise instructions to enable the user to:
identify a separation criterion that comprises:
a user-specified type of advertisement; and
a minimum distance that the advertising campaign should maintain between placement of the first buyer's advertisements and placement of advertisements of the user-specified type; and
the instructions to automatically develop the advertising campaign comprise instructions to develop the campaign so that the first buyer's advertisements and placement of advertisements of the user-specified type are positioned in a manner that does not violate the separation criterion.

9. The system of claim 1, wherein the instructions to cause a display device to present the user interface comprise instructions to provide an input by which the interface may receive from a user:
a categorization of at least one of the purchasing criteria as a preference; and
for at least one of the criteria that is categorized as a preference, a plurality of levels for the preference criterion and, for each level, a level-specific bonus amount that the first buyer will pay if the preference is satisfied in the advertising campaign.

10. The system of claim 1, wherein:
the instructions to present the user interface comprise instructions to provide an input by which the interface may receive from a user:
a categorization of two or more of the purchasing criteria as preferences, and
for each of the criteria that are categorized as a preference, a bonus amount that the first buyer will pay if the preference is satisfied in the advertising campaign; and
the instructions to automatically develop the advertising campaign comprise instructions to:
develop the campaign to satisfy at least one of the preferences that maximize a revenue opportunity for the media services provider.

11. The system of claim 10, wherein:
the instructions to present the user interface also comprise instructions to provide an input by which the interface may receive from a user a constraint on how the bonus amounts may be aggregated; and
the instructions to automatically develop the advertising campaign comprise instructions to determine a cost for the campaign that includes the bonus amounts as limited by the constraint.

12. The system of claim 1, wherein:
the instructions to present the user interface that displays a plurality of user-selectable purchasing criteria comprise instructions to enable the user to identify a zone or an interconnect for at least a portion of the campaign;
the instructions to automatically develop the advertising campaign comprise instructions to develop the portion of the campaign so that whenever a slot is allocated to an interconnect campaign, then an ad running in that slot is presented in all zones that constitute the interconnect.

13. The system of claim 1, wherein the instructions to cause a display device to present the user interface that displays the plurality of user-selectable purchasing criteria comprise instructions to:
access a set of profile data for the first buyer;
for at least one of the purchasing criteria, determine a recommended value for the purchasing criterion for the first buyer based on the profile data;
include the recommended value in the campaign as a default value.

14. The system of claim 1, wherein the instructions to develop the advertising campaign comprise instructions to:
identify a plurality of advertisements to include in the advertising campaign;
for each of the advertisements, preliminarily assign the advertisement to a position in the campaign, wherein the position comprises at least one of the following: a media asset or a temporal position; and
present the campaign to the first buyer with at least one advertising assignment presented as an unscheduled commitment for which the position will be assigned or confirmed after the first buyer accepts the advertising campaign.

15. The system of claim 1, wherein the instructions to assign each advertisement to a position comprise instructions to:
determine that a plurality of candidate positions have attributes that meet each constraint in the first buyer's purchasing criteria;
select, from the candidate positions, a group of position assignments that maximize a revenue opportunity for the media service provider while remaining within the budget criteria; and
include the group of media assets and position assignments in the advertising campaign.

16. The system of claim 1, wherein:
the instructions to cause a display device to present the user interface comprise instructions to provide an input by which the interface may receive from a user a selection of at least one preferred slot within a pod of programming, along with a monetary value that the first buyer will pay if the campaign includes an advertisement in the preferred slot; and
the instructions to implement the advertising campaign comprise instructions to:
identify a plurality of advertisements to include in the advertising campaign,
determine whether assigning an advertisement to the preferred slot will maximize a revenue opportunity for the media service provider, and
if assigning an advertisement to the preferred slot will maximize a revenue opportunity for the media service provider then assigning an advertisement to a position that corresponds to the preferred slot.

17. The system of claim 1, wherein the instructions to develop the advertising campaign further comprise additional instructions to:
receive a second set of purchasing criteria for a purchase of advertisements by a second buyer;
use the second set of purchasing criteria and at least some of the attributes in the set of programming data to develop a second advertising campaign for the second buyer;
determine that the first advertising campaign and the second advertising campaign would, if implemented, each place an advertisement in a common position;
determine whether placing the advertisement from the first advertising campaign in the common position or placing the advertisement from the second advertising campaign in the common position will maximize a revenue opportunity for the media service provider; and
place the advertisement from the advertising campaign that will maximize the revenue opportunity in the common position, and modify the other advertising campaign to identify a new position for the other advertising campaign's advertisement such that the new position will satisfy the purchasing criteria for the buyer of the other advertising campaign.

18. The system of claim 17, wherein the instructions to develop the first and second advertising campaigns further comprise additional instructions to reoptimize an allocation of inventory to each campaign in light of a new campaign request, a change in supply of inventory, or a change in demand projections.

19. The system of claim 1, wherein the instructions further comprise instructions that, when executed, cause the processor to, after the advertisement campaign has begun:
determine that the media service provider was, or likely will be, unable to satisfy a purchasing criterion that was classified as a constraint;
identify a make-good action that has a value that is appropriate to compensate the first buyer for the media service provider's inability to satisfy the purchasing criterion that was classified as a constraint; and
automatically cause the make-good action to be offered or given to the first buyer or to a representative of the media service provider.

20. The system of claim 1, wherein the instructions to develop the advertising campaign instructions to:
identify a plurality of advertisements to include in the advertising campaign;
assigning the advertisement to positions in a plurality of media assets that comprise at least two of the following:
a television program;
an on-demand program that is distributed via an online audio/video distribution service;
an electronic game;
an electronic publication; or
a web page.

21. The system of claim 1, wherein the instructions to develop the advertising campaign instructions to:
identify a plurality of advertisements to include in the advertising campaign;
assigning the advertisement to positions in a plurality of media assets that comprise one or more of the following:
a television program; or
an on-demand program that is distributed via an online audio/video distribution service.

22. The system of claim 1, wherein the instructions further comprise instructions that, when executed, cause the processor to, after presenting the indicia of the advertising campaign to the user:
receive a response comprising an acceptance of a first portion of the advertising campaign and a rejection of a second portion of the advertising campaign;
determine an updated price for the first portion of the advertising campaign;
modify the advertising campaign to exclude the second portion of the advertising campaign; and
present the modified advertising campaign and the updated price to the user for review.

23. The system of claim 1, wherein the instructions to develop the advertising campaign instructions to:
identify an alternate criterion, wherein the alternate criterion comprises an alternative or supplement to at least one of the purchasing criteria;
use the temporal attributes and the non-temporal attributes in the data set to automatically develop an alternative advertising campaign for the first buyer that satisfies the purchasing criteria as modified by the alternate criterion;
present information relating to the alternative advertising campaign to the user.

24. The system of claim 1, wherein the instructions to develop the advertising campaign instructions to:
identify an undersell constraint, wherein the undersell constraint comprises a restriction on sale of advertisements for a particular media asset or other unit of inventory; and
when automatically developing the advertising campaign, doing so such that the advertising campaign satisfies the undersell constraint.

25. The system of claim 1, wherein the instructions to develop the advertising campaign instructions to:
relax a supply constraint throughout a campaign on a per-inventory-segment basis; and
reoptimize one or more campaigns based on the relaxing.

26. The system of claim 1, further comprising additional programming instructions that cause the processor to provide a property manager configured to:
receive temporal attributes, non-temporal attributes or both for a new media asset; and
add the received attributes for the new media asset to the set of programming data for use in future advertising campaigns.

27. The system of claim 1, wherein:
the instructions to implement the media advertising campaign manager further comprise instructions that, when executed, cause a display device to present a seller-side user interface by which a seller may enter a plurality of seller-side criteria.

28. The system of claim 27, wherein:
the seller-side criteria comprise one or more of the following:
a premium value to be added to a bid or budget received from the first buyer,
a requirement to provide the first buyer with an audience having one or more specified attributes, and
a rule to factor a make-good cost in a revenue analysis when developing the advertising campaign; and
the instructions to implement the media advertising campaign manager comprise instructions to develop the advertising campaign so that it also satisfies each of the seller-side criteria.

29. The system of claim 1, wherein the instructions to implement the media advertising campaign manager further comprise instructions that, when executed:
cause an electronic device to present a seller-side user interface via which the advertising campaign is presented;
cause a processor to receive a modification of the presented advertising campaign; and
cause a processor to modify the advertising campaign to implement the received modification.

30. The system of claim 1, further comprising:
a set of additional programming data comprising temporal attributes and non-temporal attributes for a plurality of media assets that a second media service provider will present to consumers; and
wherein the instructions to develop the advertising campaign further comprise instructions to also use the parameters in the data set for the second media service provider so that the advertising campaign places advertisements in media assets for each of the media service providers.

31. A method of managing media advertising sales, comprising, by a processor:
receiving, via a user interface, one or more user-selected purchasing criteria for a purchase of advertisements by a first buyer;
accessing a set of programming data comprising temporal attributes and non-temporal attributes for a plurality of media assets that a media service provider will present to consumers;
using the temporal attributes and non-temporal attributes in the data set to automatically develop an advertising campaign for the first buyer so that the advertising campaign associates the advertisements with various media assets in the database and satisfies the user-selected purchasing criteria; and
presenting indicia of the advertising campaign to a user to review.

32. The method of claim 31, wherein:
the purchasing criteria comprise a start time, end time or duration for the advertising campaign, as well as a budget constraint for the advertising campaign;
at least one of the purchasing criteria comprises an alternative criterion;
the method also includes, for at least one of the alternative criteria, identifying a monetary value that the first buyer will pay if the advertising campaign that satisfies the alternative criterion, and
automatically developing the advertising campaign comprises:
automatically ensuring that the campaign satisfies the budget constraint and the identified start time, end time or duration,
using the identified monetary value to determine whether satisfying the alternative criterion will maximize a revenue opportunity for the media service provider, and
if satisfying the alternative criterion will maximize a revenue opportunity for the media service provider, then developing the advertising campaign so that it satisfies the alternative criterion.

33. The method of claim 31, wherein developing the advertising campaign comprises:
identifying a plurality of advertisements to include in the advertising campaign;
for each of the advertisements, preliminarily assigning the advertisement to a position; and
presenting the campaign to the first buyer with at least one advertising assignment presented as an unscheduled commitment for which the position will be assigned or confirmed after the first buyer accepts the advertising campaign.

34. The method of claim 31, wherein assigning each of the advertisements to a position comprises:
determining that a plurality of candidate positions have attributes that meet each constraint in the first buyer's purchasing criteria;
selecting, from the candidate media assets, a group of media assets and position assignments that maximize a revenue opportunity for the media service provider while remaining within a budget constraint of the first buyer; and
include the group of media assets and position assignments in the advertising campaign.

35. A system for allocating media service provider inventory to an advertising campaign comprising:
a set of programming data comprising temporal attributes and non-temporal attributes for a plurality of media assets that a media service provider will present to consumers;
a processor; and
a computer-readable medium containing programming instructions that, when executed, cause the processor to implement a media advertising campaign manager by:
receiving one or more placement criteria for placement of advertisements in an advertising campaign,
using the temporal attributes and non-temporal attributes in the data set to automatically develop the advertising campaign so that it satisfies the placement criteria, and
generating one or more data files that contain parameters for the advertising campaign, including an association of at least one advertisement with at least one of the media assets.

36. The system of claim 35, further comprising additional programming instructions that, when executed, cause a display device to output a scheduling interface that:
displays a report of the campaign including the association of at least one advertisement with the at least one of the media assets; and
permits a user to modify a distribution of at least one of the advertisements to a different position in the campaign.
